(19) United States
(12) Patent Application Publication
(10) Pub. No.: US 2005/0094987 A1
(43) Pub. Date: May 5, 2005

(54) Optical disk reproducing apparatus

(75) Inventor: Takuya Suzuki, Osaka (JP)

Correspondence Address: MORGAN LEWIS & BOCKIUS LLP, 1111 PENNSYLVANIA AVENUE NW, WASHINGTON, DC, 20004, US

(73) Assignee: FUJI ELECTRIC CO., LTD.

(21) Appl. No.: 10/974,926

(22) Filed: Oct. 28, 2004

(30) Foreign Application Priority Data
Oct. 29, 2003 (JP) P2003-368744

(51) Int. Cl. H04N 5/781

(52) U.S. Cl. 386/125; 386/126

(57) ABSTRACT

An optical disk reproducing apparatus includes: a reproducing section that reproduces information recorded on an optical disk; and a system controller that determines a title recorded on the optical disk and having a longest reproduction time based on a disk information of the optical disk and controls the reproducing section to start reproducing the title, when configured to directly reproduce a main content of the optical disk and a user operation is not inhibited.

### BACKGROUND OF THE INVENTION

1. Field of the Invention

The present invention relates to an optical disk reproducing apparatus for reproducing information recorded on an optical disk, and particularly to processing in the case of searching a main content among information recorded on an optical disk.

2. Description of the Related Art

Conventionally, an optical disk reproducing apparatus reproduces an optical disk having large storage capacity such as DVD (Digital Versatile Disk) video disk containing (retail-package disk) long hours of movie contents. In the retail-package disk containing movie data, normally, information concerning main content is used as one title and it is divided into plural chapters. Also, a setup screen, a menu screen, a logo screen of a provider etc., a logo screen of an audio-compression format, a commercial screen, a notification screen of copyright and the like other than the main content are included in the retail-package disk for cinema.

One example of a conventional optical disk reproducing apparatus is disclosed in JP-A-2002-074908.

### SUMMARY OF THE INVENTION

In the conventional optical disk reproducing apparatus, when a reproduction operation is performed after inserting an optical disk of DVD video, reproduction is executed according to authoring (procedure of reproduction ranging to a main content) on the DVD video, so that the main content is reproduced after the setup screen, the menu screen, the logo screen of the provider etc., the logo screen of the audio-compression format, the commercial screen, the notification screen of the copyright etc. as described above are displayed. Therefore, it takes a lot of time to start reproduction of the main content since the reproduction operation is performed.

Also, when a title search is made by a user operation, it is necessary for a user to know which title number corresponded to the main content. Also, the title search by the user operation had to operate a key of an operation part many times. However, these user operations do not violate standards of the DVD video because they comply with a UOP (user operation).

Incidentally, in the related art described in JP-A-2002-074908, it is described that a main content is determined by a data length, but it may become difficult to measure a length of the main content from the data length and it may become difficult to determine the main content. For example, in the case of having plural angles, data must be had in each the angle, so that data lengths result in the amount multiplied by the number of angles and it becomes difficult to measure a length of the main content and it becomes difficult to determine the main content. Also, depending on a difference in a bit rate related to resolution of a screen, a data length varies even for video of the same reproduction time, it is difficult to determine the main content by the data length. Also, since a disk manufacturer arbitrarily determines the number of chapters, the number of chapters varies depending on a disk and is not related to a length of the main content, so that it becomes difficult to determine the main content. Therefore, in the conventional art, the main content cannot necessarily be determined by the data length and thereby the main content cannot necessarily be reproduced directly.

It is therefore an object of the invention is to provide an optical disk reproducing apparatus in which it is unnecessary to perform key operations many times and a main content can be reproduced directly without viewing unnecessary information ranging to reproduction of the main content and also time taken to start the reproduction of the main content since a reproduction operation is performed can be reduced.

According to a first aspect of the invention, there is provided an optical disk reproducing apparatus including: a reproducing section that reproduces information recorded on an optical disk; and a system controller including: a user operation determination unit that determines whether or not a user operation is inhibited by a user operation information that is presently effective when configured to directly reproduce the main content of the optical disk in DVD video format; an inhibition mark display unit that displays an inhibition mark indicating operation inhibition on a display connected to the optical disk reproducing unit when the user operation determination unit determines that the user operation is inhibited; a title number detection unit that detects a total number of titles from the title search pointer table information based on the video management information management table included in the disk information of the optical disk the user operation determination unit determines that the user operation is permitted; a program chain information determination unit that checks a title search point of each the title corresponding to the total number of titles detected and determines whether or not there is a one sequential program chain title indicating that one program chain exists for one title; a reproduction time detection unit that detects reproduction time from the program chain information by the video title set information based on the title search point when the program chain information determination unit determines that there is the one sequential program chain title; and a long title reproduction unit that detects the reproduction time with respect to titles of the total number of titles and detects the title with the longest reproduction time to start reproduction.

According to a second aspect of the invention, there is provided an optical disk reproducing apparatus including: a reproducing section that reproduces information recorded on an optical disk; and a system controller that determines a title recorded on the optical disk and having a longest reproduction time based on a disk information of the optical disk and controls the reproducing section to start reproducing the title, when configured to directly reproduce a main content of the optical disk and a user operation is not inhibited.

### BRIEF DESCRIPTION OF THE DRAWINGS

The above objects and advantages of the present invention will become more apparent by describing a preferred exemplary embodiment thereof in detail with reference to the accompanying drawings, wherein:

FIG. 1 is a block diagram showing a configuration of an optical disk reproducing apparatus according to one embodiment of the invention;

FIG. 2 is a diagram showing a data structure of a video manager (VMG) in the embodiment;

FIG. 3 is a diagram showing the contents of VMGI_MAT in the embodiment;

FIG. 4 is a diagram showing the contents of TT_SRPT in the embodiment;

FIG. 5 is a diagram showing the contents of TT_SRPTI in the embodiment;

FIG. 6 is a diagram showing the contents of TT_SRP in the embodiment;

FIG. 7 is a diagram showing a data structure of VTS in the embodiment;

FIG. 8 is a diagram showing the contents of VTSI_MAT in the embodiment;

FIG. 11 is a flowchart describing processing for searching a title with the longest reproduction time in the embodiment.

### DETAILED DESCRIPTION OF THE PREFERRED EMBODIMENTS

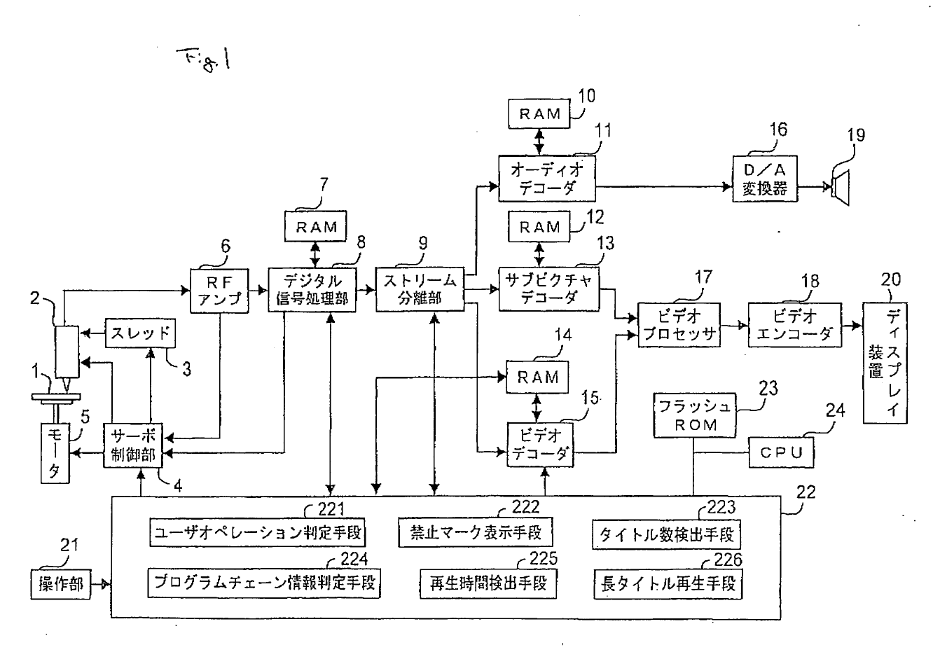

An embodiment of the invention will be described below with reference to the accompanying drawings. FIG. 1 is a block diagram showing a configuration of an optical disk reproducing apparatus according to one embodiment of the invention. The optical disk reproducing apparatus includes a spindle motor 5 for rotating an optical disk 1, an optical pickup 2 for emitting laser light for reproducing information recorded on the optical disk 1 and also receiving reflected light from the optical disk 1, a thread 3 for moving the optical pickup 2 in a radial direction of the optical disk 1, and a servo control part 4 for performing control for moving a focal position of the laser light in a vertical direction and a horizontal direction with respect to a record surface of the optical disk 1 by driving the spindle motor 5 and the thread 3 in response to instructions of a system controller 22 and also moving an objective lens (not shown) built into the optical pickup 2.

The optical disk reproducing apparatus includes an RF amplifier 6 for amplifying an RF signal which is a reading signal from the optical pickup 2 at the time of reproduction of the optical disk 1, a digital signal processing part 8 for converting the RF signal outputted from the RF amplifier 6 into digital data and then storing data generated by performing signal demodulation processing and error correction processing according to a data format of the optical disk 1 in RAM 7, and a stream separation part 9 for separating audio data, sub picture data and video data from among data streams outputted from the digital signal processing part 8 in response to instructions of the system controller 22.

The optical disk reproducing apparatus includes an audio decoder 11 for inputting the audio data outputted from the stream separation part 9 and performing predetermined decoding processing, RAM 10 for temporarily storing data in order to perform the decoding processing in the audio decoder 11, a sub picture decoder 13 for inputting the sub picture data outputted from the stream separation part 9 and performing predetermined decoding processing, RAM 12 for temporarily storing data in order to perform the decoding processing in the sub picture decoder 13, a video decoder 15 for inputting the video data outputted from the stream separation part 9 and performing predetermined decoding processing, and RAM 14 for temporarily storing data in order to perform the decoding processing in the video decoder 15.

The optical disk reproducing apparatus includes a video processor 17 for combining data outputted from the video decoder 15 and data outputted from the sub picture decoder 13 in response to instructions of the system controller 22, a video encoder 18 for converting the combined data outputted from the video processor 17 into a video signal for display and displaying an image on a display device 20, and a D/A converter 16 for converting data outputted from the audio decoder 11 into an analog audio signal and supplying the audio signal to, for example, a speaker 19.

The optical disk reproducing apparatus includes an operation part 21 having various operation keys such as a stop key for giving instructions to stop reproduction or a reproduction key for giving reproduction instructions with respect to the system controller 22, and the system controller 22 for controlling the whole apparatus. Incidentally, the operation part 21 may be a remote controller or may be an operation part provided in an operation panel of the apparatus body.

The optical disk reproducing apparatus includes flash ROM 23 in which data or programs for controlling each component of the apparatus or controlling the whole apparatus are stored, and a CPU 24 for controlling the system controller 22 by performing computation processing according to the data or programs of the flash ROM 23.

The system controller 22 includes user operation determination unit 221 for determining whether or not a user operation is inhibited by the present user operation information in the case of doing input of instructing the optical disk 1 of DVD video to directly reproduce a main content by a user, inhibition mark display unit 222 for displaying an inhibition mark indicating operation inhibition on the display device 20 when the determination result indicates inhibition of the user operation, and title number detection unit 223 for detecting the total number of titles from a title search pointer table based on a video management information management table included in disk information about the optical disk 1 when the determination result does not indicate inhibition of the user operation.

The system controller 22 further includes program chain information determination unit 224 for determining whether or not there is a one sequential program chain title indicating that one program chain is present in one title by checking a title search point of each the title corresponding to the total number of titles detected, reproduction time detection unit 225 for detecting reproduction time from program chain information by video title set information based on the title search point when the determination result indicates that there is the one sequential program chain title, and long title reproduction unit 226 for detecting the reproduction time with respect to titles of the total number of titles and detecting the title with the longest reproduction time to execute reproduction.

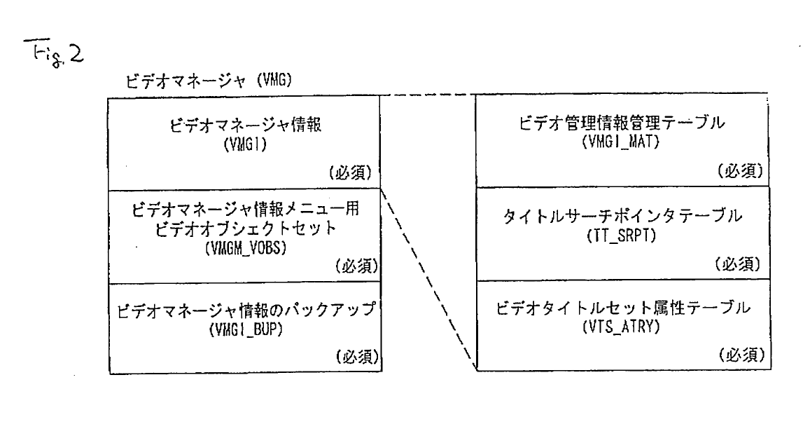

FIG. 2 is a diagram showing a data structure of a video manager (VMG) in the present embodiment. The video manager (VMG) includes video manager information (VMGI), a video object set (VMGM_VOBS) for video manager information menu, and backup (VMGI_BUP) of the video manager information. The video manager information (VMGI) includes a video management information management table (VMGI_MAT), a title search pointer table (TT_SRPT), and a video title set attribute table (VTS_ATRT).

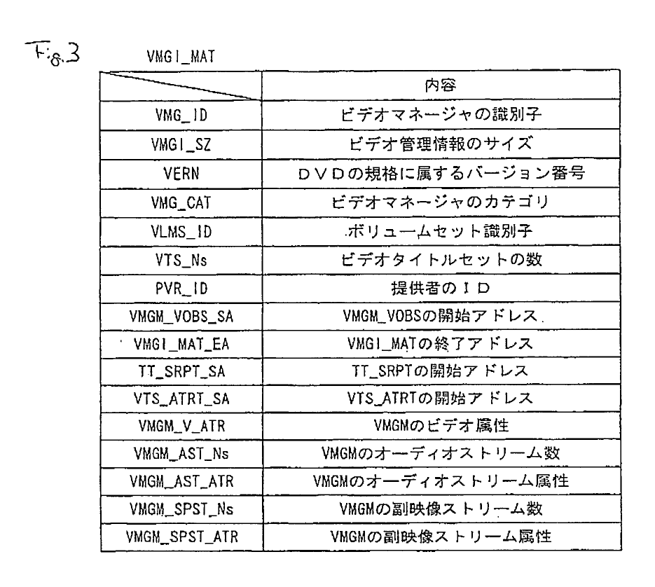

FIG. 3 is a diagram showing the contents of VMGI_MAT in the embodiment. As shown in the FIG. 3, VMG_ID is an identifier of VMG information. VMGI_SZ is a size of VMGI. VERN is a version number of DVD standards. VMG_CAT is a video manager category and, for example, a flag as to whether or not a copy is inhibited is described. VLMS_ID is an identifier of a volume set. VTS_Ns is the number of VTSs. PVR_ID is an identifier of a data supplier. VMGM_VOBS_SA is a start address of VMGM_VOBS. VMGI_MAT_EA is an end address of VMGI_MAT. TT_SRPT_SA is a start address of TT_SRPT.

VTS_ATRT_SA is a start address of VTS_ATRT. VMGM_V_ATR, VMGM_AST_Ns, VMGM_AST, VMGM_SPST_Ns and VMGM_SPST_ATR are a video attribute, the number of audio streams, an audio stream attribute, the number of sub video streams and a sub video stream attribute of VMGM, respectively.

FIG. 4 is a diagram showing the contents of TT_SRPT in the embodiment. In the FIG. 4, information (TT_SRPTI) about TT_SRPT and TT_SRP for each title are described in TT_SRPT.

FIG. 5 is a diagram showing the contents of TT_SRPTI in the embodiment. In the FIG. 5, the number (TT_SRP_Ns) of TT_SRPs and an end address (TT_SRPT_EA) of TT_SRPT, etc. are described in TT_SRPTI.

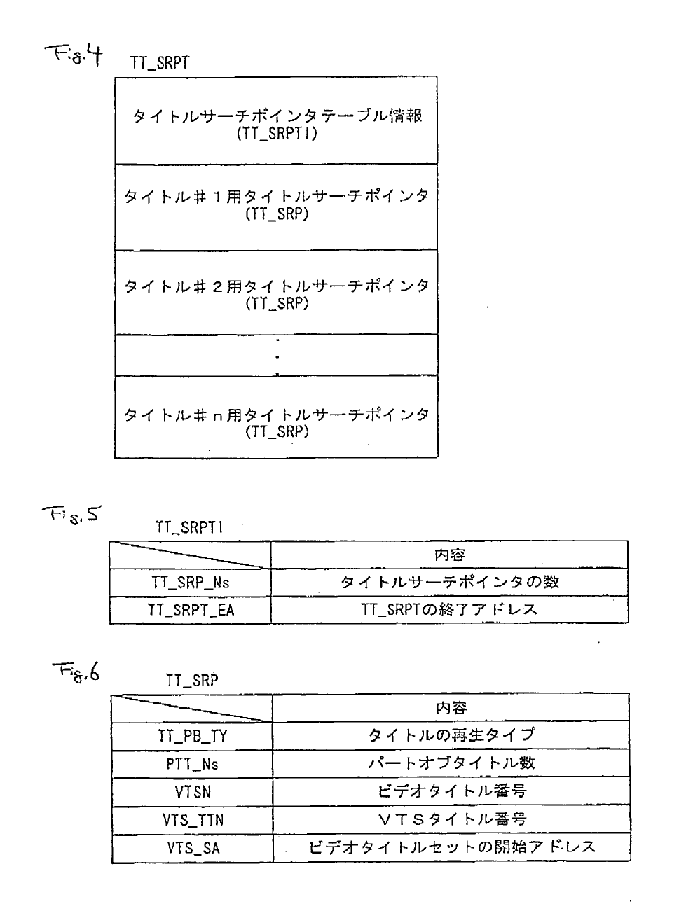

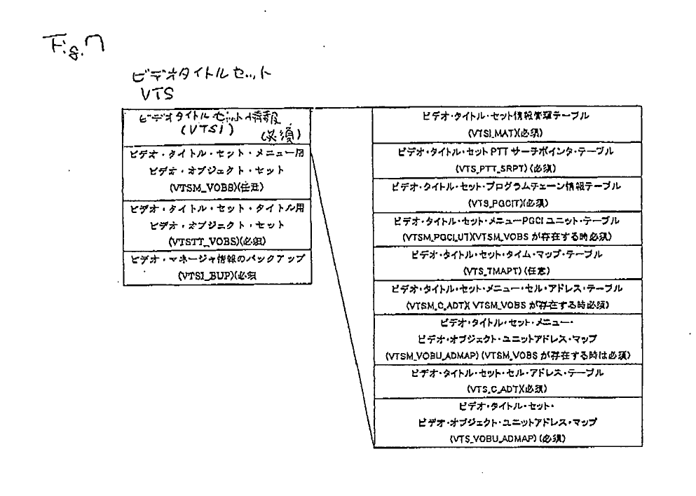

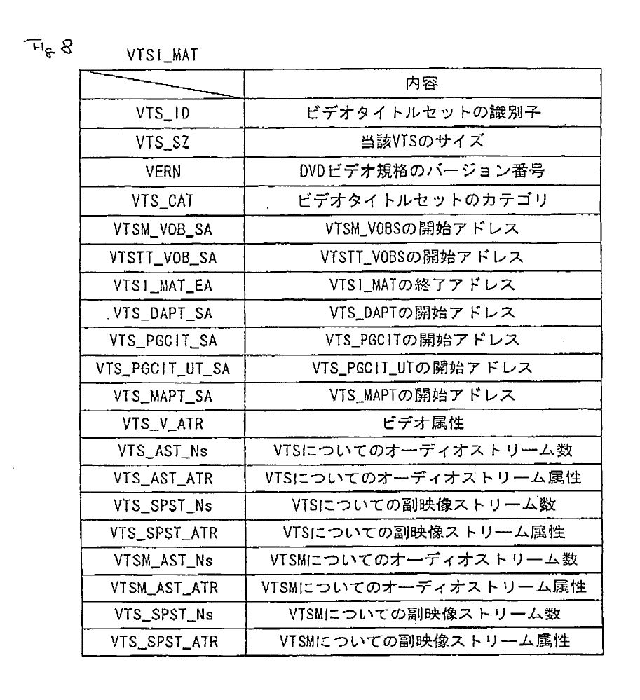

FIG. 6 is a diagram showing the contents of TT_SRP in the embodiment. In the FIG. 6, a reproduction type (TT_PB_TY) of a title, the number (PTT_Ns) of parts of title, a VTS number (VTSN), a title number (VTS_TTN) of VTS and a start address (VTS_SA) of VTS, etc. are described in TT_SRP.

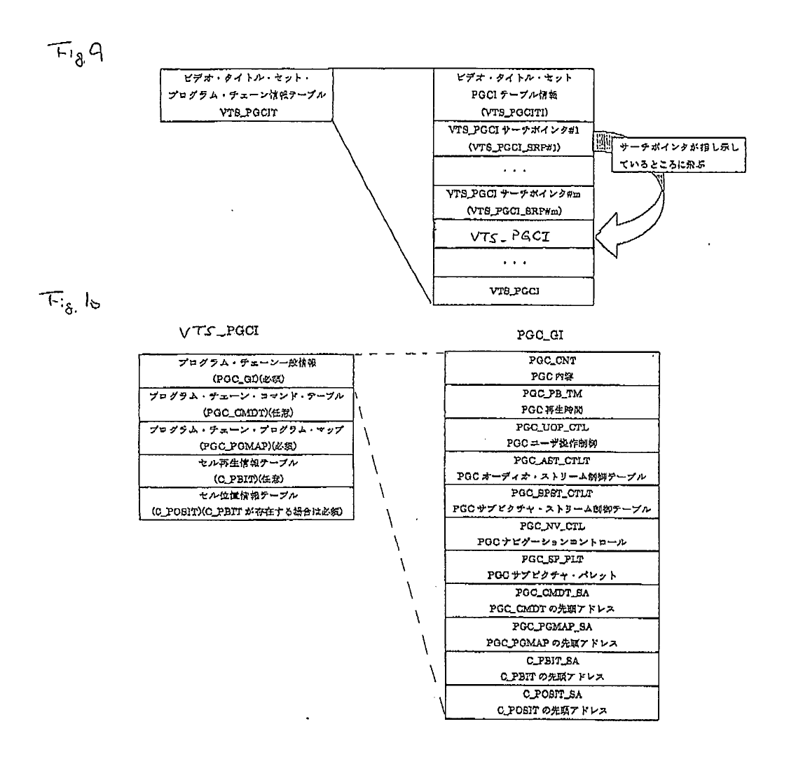

FIG. 7 is a diagram showing a data structure of VTS in the embodiment. In the FIG. 7, a VTS information management table (VTSI_MAT), a video title set PPT search pointer table (VTS_PPT_SRPT), and a VTS program chain table (VTS_PGCIT), etc. are described in VTSI which is control data of VTS.

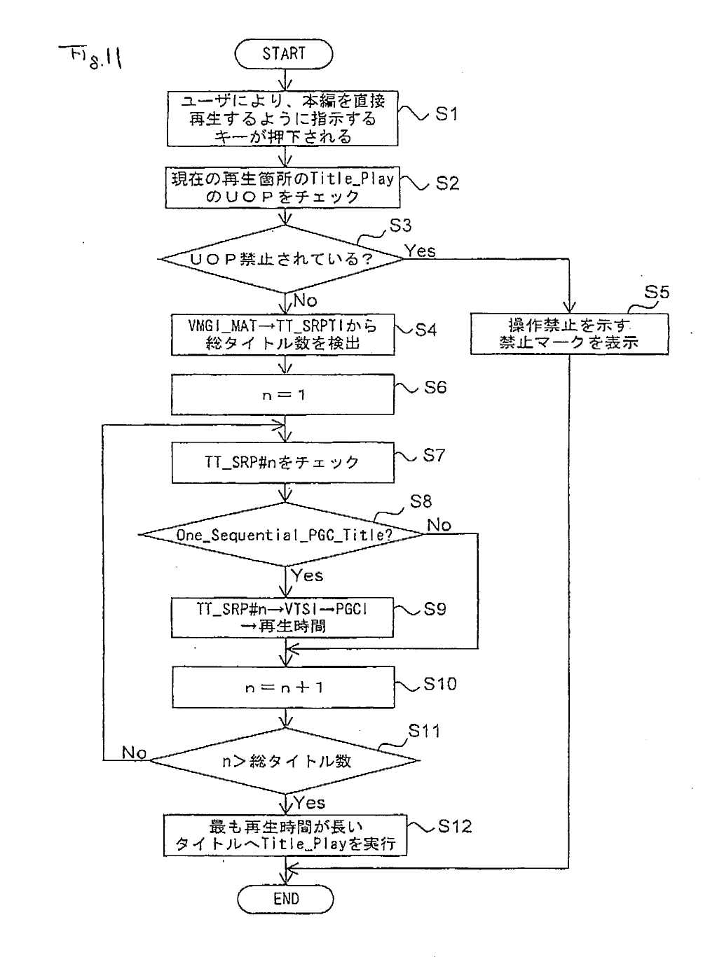

FIG. 8 is a diagram showing the contents of VTSI_MAT in the embodiment. In FIG. 8, VTS_ID is an identifier of VTS information. VTS_SZ is a size of VTS. VERN is a version number of DVD video standards. VTS_CAT is an attribute of VTS. VTSM_VOB_SA is a start address of VTSM_VOBS for a menu of VTS. VTSTT_VOB_SA is a start address of VTSTT_VOBS for a title of VTS.

VTSI_MAT_EA is an end address of VTSI_MAT. VTS_DAPT_SA is a start address of VTS_DAPT. VTS_PGCIT_SA is a start address of VTS_PGCIT. VTS_PGCIT_UT_SA is a start address of VTS_PGCIT_UT. VTS_MAPT_SA is a start address of VTS_MAPT. VTS_V_ATR is a video attribute of VTS.

VTS_AST_Ns, VTS_AST_ATR, VTS_SPST_Ns and VTS_SPST_ATR are the number of audio streams, an audio stream attribute, the number of sub video streams and a sub video stream attribute of VTSTT_VOBS for a title, respectively. Also, VTSM_AST_Ns, VTSM_AST_ATR, VTS_SPST_Ns and VTS_SPST_ATR are the number of audio streams, an audio stream attribute, the number of sub video streams and a sub video stream attribute of VTSM_VOBS for a menu, respectively.

FIG. 9 is a diagram showing contents of the VTS program chain, information table (VTS_PGCIT). As shown in FIG. 9, VTS_PGCIT includes a VTS PGCI table information (VTS_PGCITI), VTS_PGCI search pointers (VTS_PGCI_SRP#1˜VTS_PGCI_SRP#m) that each indicates which VTS_PGCI to be referred to, and a plurality of VTS program chains (VTS_PGCI).

FIG. 10 is a diagram showing contents of VTS_PGCI. As shown in FIG. 10, VTS_PGCI includes a program chain general information (PGC_GI), a program chain command table (PGC_CMDT), a program chain program map (PGC_PGMAP), a cell reproduction information table (C_PBIT), and a cell position information table (C_POSIT). The PGC_GI includes PGC contents (PGC_CNT), PGC reproducing time (PGC_PB_TM), PGC user operation control (PGC_UOP_CTL), PGC audio stream control table (PGC_AST_CTLT), PGC subpicture stream control table (PGC_SPST_CTLT), PGC navigation control (PGC_NV_CTL), PGC subpicture palette (PGC_SP_PLT), a start address of PGC_CMDT (PGC_CMDT_SA), a start address of PGC_PGMAP (PGC_PGMAP_SA), a start address of C_PBIT (C_PBIT_SA), and a start address of C_POSIT (C_POSIT_SA).

FIG. 11 is a flowchart describing processing for searching a title with the longest reproduction time in the embodiment. The processing for searching a title with the longest reproduction time will be described with reference to the flowchart.

First, when a key of the operation part 21 for instructing the optical disk 1 of DVD video to directly reproduce a main content by a user is pressed down (step S1), reproduction processing ranging to reproduction of the main content is started and the user operation determination unit 221 of the system controller 22 checks a UOP (user operation) of Title_Play of the present reproduction place (step S2), and determines whether or not the UOP is inhibited (step S3). When the determination result indicates inhibition of the UOP, the inhibition mark display unit 222 displays an inhibition mark indicating operation inhibition on the display device 20 (step S5). By the display, the user can know that the main content cannot be reproduced directly.

On the other hand, when the determination result does not indicate inhibition of the UOP, the title number detection unit 223 detects the total number of titles from title search pointer table information (TT_SRPTI) based on a video management information management table (VMGI_MAT) included in disk information about the optical disk 1 (step S4), and sets a count value n at a numeric value 1 (step S6).

Next, the program chain information determination unit 224 checks a title search point (TT_SRP#n) of each the title corresponding to the total number of titles detected (step S7), and determines whether or not there is a one sequential program chain title (One_Sequential_PGC_Title) indicating that one program chain is present in one title by referring to the reproduction type of a title (TT_PB_TY) (step S8).

When the determination result indicates that there is not the one sequential program chain title (One_Sequential_PGC_Title), the flowchart shifts to step S10. Incidentally, it is difficult to detect the reproduction time of titles other than the one sequential program chain title (One_Sequential_PGC_Title), so that the reproduction time of the titles is ignored. The reason is that when there are plural program chain titles (PGC_Title), there are many reproduction paths of titles and when there are titles selected by a user, the reproduction time may vary depending on the titles selected by the user and it becomes difficult to detect the reproduction time, and therefore the reproduction time is ignored.

When the determination result indicates that there is the one sequential program chain title (One_Sequential_PGC_Title), the reproduction time detection unit 225 detects reproduction time from program chain information (PGCI) by video title set information (VTSI) based on the title search point (TT_SRP#n) (step S9). Here, reproduction time is detected from the program chain information (PGCI) by the video title set information (VTSI) based on the title search point (TT_SRP#n) of n=1.

Then, in order to detect reproduction time from the program chain information (PGCI) by the video title set information (VTSI) based on the title search point (TT_SRP#n) of n=2, the count value is set at n=n+1 (step S10) and when the count value n is less than or equal to the total number of titles, the flowchart returns to step S7 and the processing of steps S8 and S9 is performed and reproduction time is detected from the program chain information (PGCI) by the video title set information (VTSI) based on the title search point (TT_SRP#n) of n=2.

In like manner below, processing for n=3, 4, 5 . . . (steps S7, S8, S9, S10 and S11) is repeated and when the count value n exceeds the total number of titles, the long title reproduction unit 226 detects a title with the longest reproduction time among the detected reproduction times to execute reproduction (step S12). As a result of the, the title with the longest reproduction time is probably a main content, so that the main content instructed by the user in step S1 is directly reproduced.

When detecting the reproducing time for each of the title, in particular, the information is referred to sequentially in the following order: TT_SRP, VTSI_MAT, VTSI_PTT_SRPT, VTS_PGCIT, VTS_PGCI_SRP, VTS_PGCI, and PGC_PB_TM.

According to the embodiment as described above, there is provided the system controller 22 in which when input of instructing the optical disk 1 of DVD video to directly reproduce a main content by a user is done and a UOP (user operation) is not inhibited, based on disk information about the optical disk 1, a title with the longest reproduction time is detected to execute reproduction, so that the title with the longest reproduction time can be detected and thereby it is unnecessary to perform key operations many times and the main content can be reproduced directly without viewing unnecessary information ranging to reproduction of the main content and also time taken to start the reproduction of the main content since a reproduction operation is performed can be reduced.

According to the embodiment as described above, there is provided a system controller having user operation determination unit for determining whether or not a user operation is inhibited by the present user operation information in the case of doing input of instructing an optical disk of DVD video to directly reproduce a main content by a user, inhibition mark display unit for displaying an inhibition mark indicating operation inhibition on display means when the determination result indicates inhibition of the user operation, title number detection unit for detecting the total number of titles from title search pointer table information based on a video management information management table included in disk information about the optical disk when the determination result does not indicate inhibition of the user operation, program chain information determination unit for checking a title search point of each the title corresponding to the total number of titles detected and determining whether or not there is a one sequential program chain title indicating that one program chain is present in one title, reproduction time detection unit for detecting reproduction time from program chain information by video title set information based on the title search point when the determination result indicates that there is the one sequential program chain title, and long title reproduction unit for detecting the reproduction time with respect to titles of the total number of titles and detecting the title with the longest reproduction time to execute reproduction. Therefore, the title with the longest reproduction time can be detected and thereby it is unnecessary to perform key operations many times and the main content can be reproduced directly without viewing unnecessary information ranging to reproduction of the main content and also time taken to start the reproduction of the main content since a reproduction operation is performed can be reduced.

Also, according to the embodiment, there is provided a system controller in which when input of instructing an optical disk to directly reproduce a main content by a user is done and a user operation is not inhibited, based on disk information about the optical disk, a title with the longest reproduction time is detected to execute reproduction, so that the title with the longest reproduction time can be detected and thereby it is unnecessary to perform key operations many times and the main content can be reproduced directly without viewing unnecessary information ranging to reproduction of the main content and also time taken to start the reproduction of the main content since a reproduction operation is performed can be reduced.

Although the present invention has been shown and described with reference to a specific preferred embodiment, various changes and modifications will be apparent to those skilled in the art from the teachings herein. Such changes and modifications as are obvious are deemed to come within the spirit, scope and contemplation of the invention as defined in the appended claims.

1. An optical disk reproducing apparatus comprising:
a reproducing section that reproduces information recorded on an optical disk; and
a system controller including:
a user operation determination unit that determines whether or not a user operation is inhibited by a user operation information that is presently effective when configured to directly reproduce the main content of the optical disk in DVD video format;
an inhibition mark display unit that displays an inhibition mark indicating operation inhibition on a display connected to the optical disk reproducing unit when the user operation determination unit determines that the user operation is inhibited;
a title number detection unit that detects a total number of titles from the title search pointer table information based on the video management information management table included in the disk information of the optical disk the user operation determination unit determines that the user operation is permitted;
a program chain information determination unit that checks a title search point of each the title corresponding to the total number of titles detected and determines whether or not there is a one sequential program chain title indicating that one program chain exists for one title;
a reproduction time detection unit that detects reproduction time from the program chain information by the video title set information based on the title search point when the program chain information determination unit determines that there is the one sequential program chain title; and
a long title reproduction unit that detects the reproduction time with respect to titles of the total number of titles and detects the title with the longest reproduction time to start reproduction.

2. An optical disk reproducing apparatus comprising:
a reproducing section that reproduces information recorded on an optical disk; and
a system controller that determines a title recorded on the optical disk and having a longest reproduction time based on a disk information of the optical disk and controls the reproducing section to start reproducing the title, when configured to directly reproduce a main content of the optical disk and a user operation is not inhibited.

3. The optical disk reproducing apparatus according to claim 2, wherein in a case where the optical disk is an optical disk in DVD video format, the system controller refers to at least one of a video management information management table, a title search pointer table information, a one sequential program chain title, and a video title set information and program chain information, as the disk information to determine the title.

4. The optical disk reproducing apparatus according to claim 3, wherein the system controller includes:
a user operation determination unit that determines whether or not a user operation is inhibited by a user operation information that is presently effective when configured to directly reproduce the main content of the optical disk;
an inhibition mark display unit that displays an inhibition mark indicating operation inhibition on a display connected to the optical disk reproducing unit when the user operation determination unit determines that the user operation is inhibited;
a title number detection unit that detects a total number of titles from the title search pointer table information based on the video management information management table included in the disk information of the optical disk the user operation determination unit determines that the user operation is permitted;
a program chain information determination unit that checks a title search point of each the title corresponding to the total number of titles detected and determines whether or not there is a one sequential program chain title indicating that one program chain exists for one title;
a reproduction time detection unit that detects reproduction time from the program chain information by the video title set information based on the title search point when the program chain information determination unit determines that there is the one sequential program chain title; and
a long title reproduction unit that detects the reproduction time with respect to titles of the total number of titles and detects the title with the longest reproduction time to start reproduction.
